(19) United States
(12) Patent Application Publication
(10) Pub. No.: US 2014/0013917 A1
(43) Pub. Date: Jan. 16, 2014

(54) JIGSAW WITH AN EXCHANGEABLE SAW BLADE GUIDE

(71) Applicant: Samuel Meier, Subingen (CH)

(72) Inventor: Samuel Meier, Subingen (CH)

(73) Assignee: Robert Bosch GmbH, Stuttgart (DE)

(21) Appl. No.: 13/977,676

(22) PCT Filed: Nov. 29, 2011
(86) PCT No.: PCT/EP2011/071275

§ 371 Date: Sep. 27, 2013

(30) Foreign Application Priority Data
Dec. 30, 2010 (DE) 10 2010 056 504.0

(51) Int. Cl. B23D 51/02

(52) U.S. Cl. CPC B23D 51/025
USPC 83/829

(57) ABSTRACT

A jigsaw includes at least one saw blade guide that supports a back of a saw blade of the jigsaw. The jigsaw further includes a fastening element that has a bearing portion on which the saw blade guide is mounted, in particular in a rocking manner, so that the saw blade guide is held on the jigsaw. The fastening element is configured to be repeatedly positioned on the jigsaw in a locking position and an unlocking position such that the saw blade guide is exchangeable.

### PRIOR ART

The invention is based on a jigsaw according to the preamble of claim 1.

There are known hand-guided jigsaws, imparted to the saw blades of which, in addition to the vertical back and forth motion, there is a horizontal pendulum motion superimposed on the vertical sawing motion.

The pendulum motion is transmitted from the pendulum mechanism to the saw blade in that, for example, an eccentric motion is transmitted, from the eccentric of an eccentric gearwheel that can be driven in rotation and that generates the sawing motion, to a fork lever having an open fork for the purpose of eccentric engagement. In this case, the eccentric engages in a gate aperture of the pivotally mounted fork lever, imparts to the latter a back and forth pivoting motion.

With its end that pivots back and forth, the fork lever projects out of the transmission housing and, with this end, is supported directly on an arm of a two-armed saw blade guide—also referred to as a roller guide—, which, for its part, is mounted in a pivotable manner transversely in relation to the pivot plane of the fork lever. Via a support roller, or pendulum roller, that is rotatably mounted on its other arm, the saw blade guide is supported against the back of the saw blade and transmits its pendulum motion to the latter.

DE 198 05 675 A1 discloses a jigsaw having a saw blade guide, on which a back of a saw blade of the jigsaw is supported, wherein the fastening element has a bearing portion on which the saw blade guide is mounted, in particular with a pendulum motion, such that the saw blade guide is held on the jigsaw. The saw blade guide in this case is fixedly mounted in the orbital-action jigsaw. For this purpose, the saw blade guide is connected to the jigsaw by means of a pin, which is pressed into the casing of the jigsaw. The roller and the associated saw blade guide cannot be easily exchanged by the user. Wear of the rollers results in impairment of the cutting quality or even in a more rapid destruction of the saw blades.

Further documents that disclose a fastening of the saw blade guide via a pin held by means of a press fit are DE 10 2008 056 528 A1, DE 10 2009 000 034 A1, EP 1 513 645 B1, WO 2009/156210 A1 and US 2007/0180711 A1.

An alternative method of fastening the saw blade guide is known from EP 736 353 A1, where the saw blade guide, realized as a bearing block, is fastened by means of a rivet, which also means that the user cannot easily exchange the saw blade guide.

In all cases, the saw blade guides could be exchanged. However, this would result in the press fit becoming worn or in the fastening element—in the case of a rivet—having to be destroyed.

### DISCLOSURE OF THE INVENTION

The invention having the features of claim 1 has the advantage that the user himself can easily fit saw blade guides for the application required by the user. Thin blades presuppose a narrow saw blade guide—thick blades presuppose a wide guide. The user will thus have fitted the desired saw blade guide within a short period of time, and can therefore realize an optimal guide, according to the selected saw blade. Changing of the saw blade guide ensures, on the one hand, that the quality of the rollers remains high, as well as a maximum service life of the saw blades.

This is rendered possible with a jigsaw having at least one saw blade guide, on which a back of a saw blade of the jigsaw is supported, wherein the fastening element has a bearing portion on which the saw blade guide is mounted, in particular with a pendulum motion, such that the saw blade guide is held on the jigsaw, and wherein the fastening element can be repeatedly positioned on the jigsaw in a locking position and an unlocking position, such that the saw blade guide can be exchanged.

Since the fastening element has an actuating portion that can be actuated, in particular, by a user, in order to lock and unlock the fastening element, operation is particularly simple.

Since the fastening element has a locking portion, by means of which the fastening element can be locked and unlocked on the jigsaw, secure locking is ensured.

The jigsaw according to the invention is particularly advantageous in the case of a saw blade guide that is mounted with a pendulum motion on the bearing portion.

In a particularly advantageous development, the jigsaw has a U-shaped recess for the saw blade guide, which is disposed between two limbs of the U-shaped recess, wherein the fastening element extends through the two limbs, and wherein the fastening element has at least one slide portion, which is disposed in at least one limb and is seated in a sliding manner in the limb.

Since the actuating portion has a recess for a tool, in particular a screwdriver, it can be operated particularly easily. Secure locking is also achieved.

Since the fastening element has a thread, by means of which it can be screwed into the jigsaw, a design is achieved that is particularly easy to produce.

It is particularly advantageous if the thread has a coating that makes it difficult for the fastening element to be detached.

It is made particularly easy for the fastening element to be disposed in a captive manner on the jigsaw, owing to the fact that the fastening element is disposed in a displaceable manner, wherein the bearing portion has a first cross-sectional face, wherein adjoining the bearing portion there is a slide portion having a second cross-sectional face that is smaller than the first cross-sectional face, and wherein the saw blade guide has a recess by means of which it can be taken transversely from the fastening element.

A system consisting of at least one jigsaw and of a plurality of saw blade guides for the at least one jigsaw, wherein the saw blade guides are designed for differing saw blades, enable users to effect particularly easy adaptations to differing sawing applications.

### DRAWING

The invention is explained more fully in the following on the basis of an exemplary embodiment, with an accompanying drawing. In the drawing:

FIG. 1 shows a side view of the jigsaw according to the invention,

FIG. 2 shows a perspective view of a portion of the jigsaw having a first fastening,

FIG. 3 shows an exploded representation of FIG. 2,

FIG. 4 shows a front view of the fastening of FIG. 2,

FIG. 5 shows an exploded representation of FIG. 4,

FIG. 6 shows an exploded representation similar to FIG. 3, but with a modified roller,

FIG. 7 shows a second exemplary embodiment of a fastening, and

FIG. 8 shows a section according to the section lines VIII-VIII in FIG. 7.

### EXEMPLARY EMBODIMENT

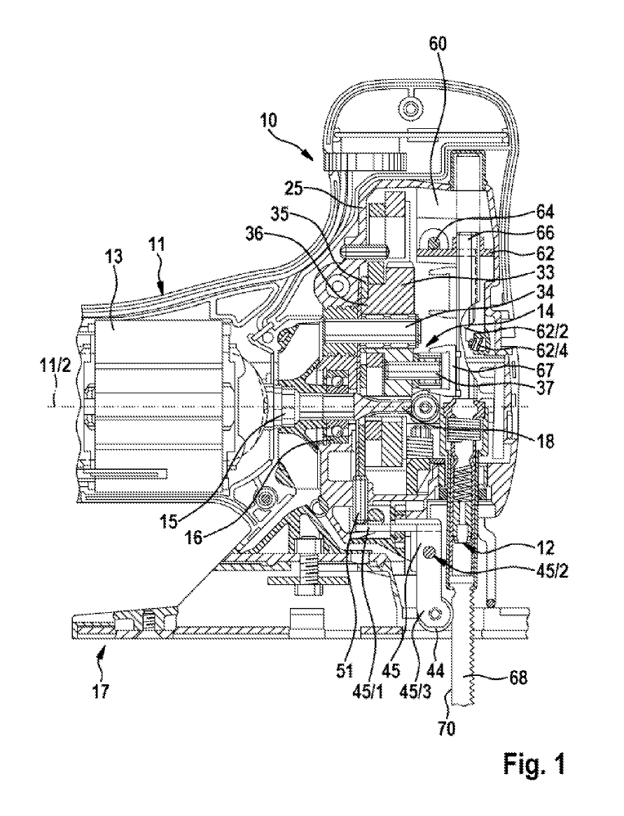

The longitudinal section of a hand-guided jigsaw 10, shown in FIG. 1, shows the casing 11 thereof, which carries a motor 13 and, in the transmission housing 25, a transmission 14. The transmission 14 transmits the rotary motion of the motor 13 to a lift rod 66 and to a saw blade 68 clamped at the lower end of the lift rod 66. The casing 11 is disposed, so as to be adjustable in respect of angle, on a base plate 17, in order to be safely placed and guided on a workpiece, not represented.

The motor 13 has a motor shaft, serving as a drive shaft 15, which is rotatably mounted in a shaft bearing 16 in the casing 11. The drive shaft 15 terminates in a drive pinion 18, which meshes with a spur gearwheel 33 that is mounted so as to be rotatable about an axle 34 in the transmission housing 25.

On its outside face that faces toward the motor 13, the spur gearwheel 33 carries an eccentric 36, which is designed as a collar and engages in a guided manner in a slot-type recess of a fork lever 35.

On the front outside face of the gearwheel 33 that faces away from the motor 13, the gearwheel carries an eccentrically disposed crank 37, which engages in a slot-type slide piece 67 that is connected, especially in a rotationally fixed manner, to the lift rod 66, and which converts the rotary motion of the gearwheel 33 into a vertical back and forth motion of the lift rod 66.

The lift rod 66 is mounted, so as to be displaceable back and forth longitudinally in the transmission housing 25, in an upper support stirrup 62 that carries a bearing bush. The support stirrup 62 is mounted, in the transmission space 60 of the jigsaw 10, so as to be movable in a pivoting manner about a pin 64 that is mounted parallelwise in relation to the base plate 17 and transversely in relation to the longitudinal axis 11/2 of the housing 11. The pin 64 constitutes the rotation point for the pendulum motion of the saw blade 68, together with the lift rod 66.

The support stirrup 62 carries two support limbs 62/2, extending downward symmetrically in relation to the center point of the bearing bush and transversely in relation to the longitudinal axis 11/2 of the casing 11, between whose rod-type centering lugs and the inner end wall of the transmission housing 25 a respective compression spring 62/4 is supported and seeks to press the support stirrup 62 backward in an oscillating manner, together with the lift rod 66, about the axis of the pin 64. As a result, after each pendulum stroke running in the direction of advance, the lift rod 66 is pressed back, together with the saw blade 68, by the action of the compression springs 62/4. In this case, a saw blade guide, in the form of a roller lever 45, is likewise pressed backward by means of the back 70 of the saw blade 68 and, consequently, the ram 51 is pressed upward, against the lug 35/3 of the fork lever and follows the latter, or the lug 35/3 thereof, upward in the pendulum motion.

The support limbs 62/2 are disposed such that the slide piece 67, which likewise extends transversely in relation to the longitudinal axis 11/2 of the axis of the casing 11, is securely supported thereon from behind by its two outer ends, or shoulders, such that the lift rod 66, during its upward and downward motion, slides, guided against torsion, with its slide piece 67 on the support limbs 62/2. For the lift rod 66, this creates a particularly robust support bearing against torsion, in order to take up the torque that is produced during curve cutting by means of the jigsaw 10 and that is transmitted, via the jigsaw blade 68, to the lift rod 66. The support stirrup 62 in this case prevents twisting of the transmission housing during curve sawing, and enables the transmission housing to be of a light structural design, such that its service life is improved and, moreover, the support stirrup 62, via its slide limbs 62/2, imparts the pendulum return stroke to the lift rod 66.

As the gearwheel 33 rotates, the eccentric 36 on the back side of the gearwheel 33 transmits the orbital motion thereof to the one-armed fork lever 35, such that the latter executes a pendulum motion about a rotation point and thereby, by means of its lug, transmits its back and forth pivoting motion to a ram 51. As the fork lever 35 pivots back and forth, the ram 51 is moved up and down by the fork lever lug, which slides with a pendulum motion over the upper outside face of the ram 51.

With its lower outside face, the ram 51 is supported on a machine-side arm 45/1 of a roller lever 45. The latter is mounted in the transmission housing 60 so as to be pivotable about a rotation point 45/2 and, on its arm 45/3 on the saw-blade side, accommodates a roller 44 in a rotatable manner. The roller 44 is supported against the back 70 of the saw blade 68. During its pivoting motion about the rotation point 45/2, the roller lever 45 imparts to the saw blade 68 a pendulum motion that runs parallelwise in relation to the longitudinal axis 11/2 of the casing 11.

The saw blade 68 is detachably clamped into a clamping device 12 in the lower end of the lift rod 66. The fork lever 35, by overlapping with a slot, is placed in a sliding manner on to the eccentric 36 of the gearwheel 33.

The ram 51 projects in a sealed manner out of the transmission housing 60, and at one end contacts the roller lever 45 and at the other end contacts the fork lever 35, such that neither the fork lever 35 nor the roller lever 45 has to extend through the transmission housing 60 during its pendulum motion. As a result, the sealing of the transmission housing 60 is particularly simple and effective for the through passage of the ram 51, since it can be kept cylindrical and correspondingly small. Moreover, the ram 51 can transmit only a pure axial motion, and not a transverse force, to the roller lever 45, such that the pendulum motion thereof is effected particularly cleanly, without transverse oscillations.

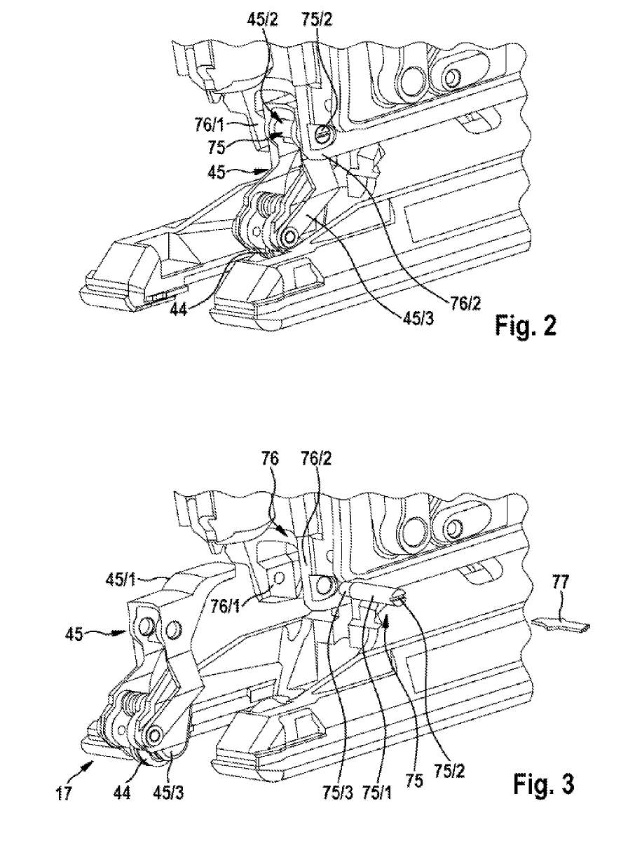

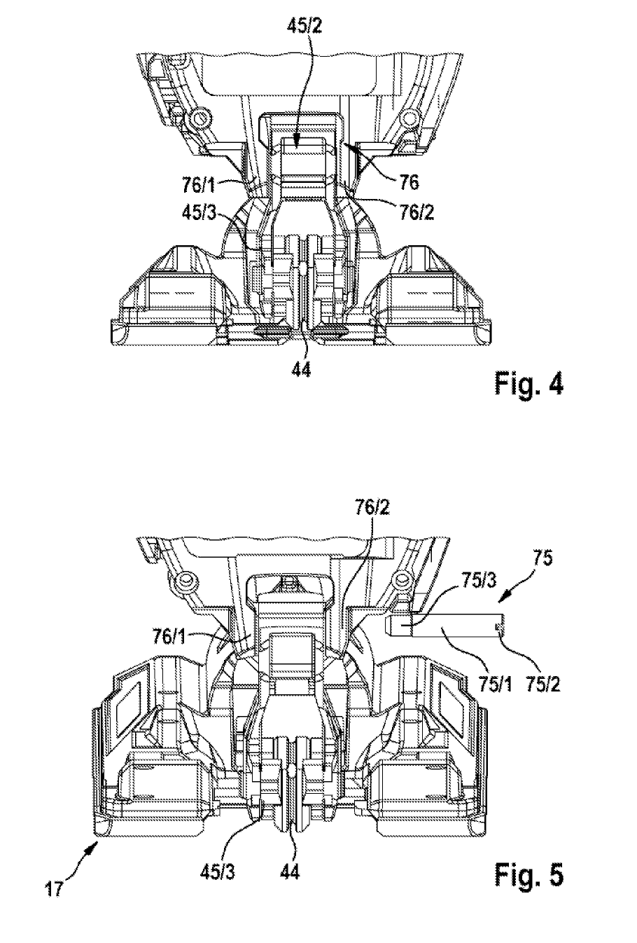

FIGS. 2 to 6 show in detail the jigsaw 10, having a saw blade guide 45, on which a back 70 of a saw blade of the jigsaw 10 is supported. Serving as a rotation point 45 is a fastening element 75, preferably in the form of a stud, which has a bearing portion 75/1 on which the saw blade guide 45 is mounted, such that the saw blade guide 45 is held on the jigsaw 10. The fastening element 75 can be positioned repeatedly, or over again, in a locking position and in an unlocking position, on the jigsaw 10, such that the saw blade guide 45 can be easily exchanged.

For this purpose, the fastening element 75 has an actuating portion 75/2 in the form of a recess for a screwdriver 77, which can be actuated by a user in order to lock and unlock the fastening element 75. The fastening element 75 additionally has a locking portion 75/3 in the form of a thread, by means of which it can be locked and unlocked on the jigsaw. The thread has a coating 75/4, which makes it difficult for the fastening element 75 to be detached.

It must be emphasized that the saw blade guide 45, 450 is mounted with a pendulum motion on the bearing portion 75/1; 750/1. However, realization without a pendulum motion is also conceivable.

The jigsaw 10 has a U-shaped recess 76 for the saw blade guide 45, which is disposed between two limbs 76/1, 76/2 of the U-shaped recess 76, wherein the fastening element 75 extends through the two limbs 76/1, 76/2. The fastening element 75 has at least one slide portion 75/3, which is disposed in a limb 76/1 and is seated in a sliding manner in the limb 76/1.

In this exemplary embodiment, the fastening element, realized as a threaded stud, is screwed into the casing cover of the jigsaw 10 and is released by means of the screwdriver 77. The saw blade guide, as a roller-lever assembly, can then be removed and a new saw blade guide can be inserted. The threaded stud is then screwed in again. As already stated, the threaded stud has a coating. This prevents the parts from being inadvertently detached.

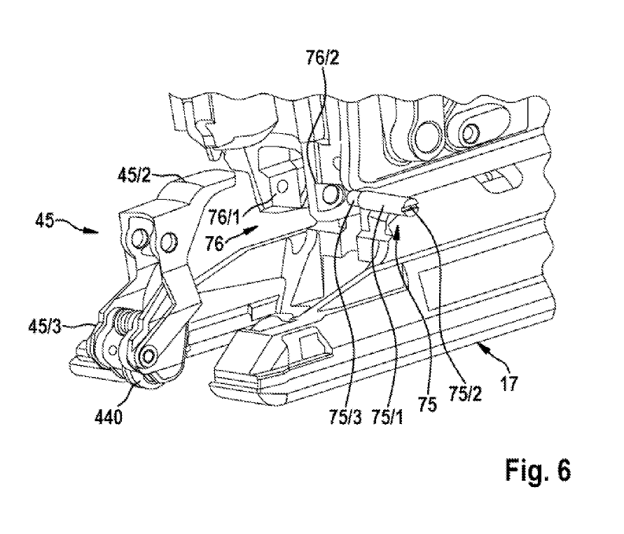

It must also be mentioned that FIG. 6 shows an alternative roller 440, in order to illustrate how easily an optimized system can be realized for differing saw blades 68.

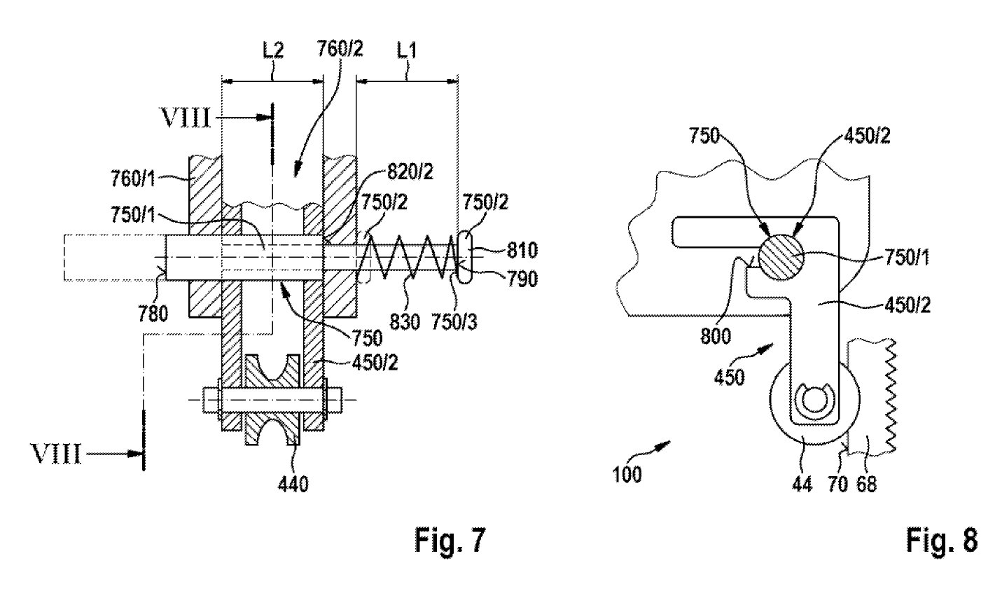

FIGS. 7 and 8 show a jigsaw 100, having a saw blade guide 450, on which a back 70 of a saw blade 68 of the jigsaw 10 is supported, wherein the fastening element 750 has a bearing portion 750/1 on which the saw blade guide 450 is mounted, in particular with a pendulum motion, such that the saw blade guide 450 is held on the jigsaw 10, and wherein the fastening element 750 can be repeatedly positioned in a locking position and in an unlocking position on the jigsaw 10, such that the saw blade guide 450 can be exchanged.

The fastening element 750 has an actuating portion 750/2, by means of which a user can be actuated, in order to lock and unlock the fastening element 750, by displacement, for the saw blade guide 450. The fastening element 750 is preferably in the form of a stud having a plurality of portions having round cross-sectional faces.

The fastening element 750 has a locking portion, in the form of a collar 810 and a shoulder 820, by means of which the fastening element can be locked and unlocked on the jigsaw 100. The collar 810 is welded, for example, to the slide portion 750/3. The slide portion 750/3 can also be pressed into an annular collar 810.

The saw blade guide 450 is likewise preferably mounted with a pendulum motion on the bearing portion 750/1.

The jigsaw 100 likewise has a U-shaped recess 760 for the saw blade guide 450, which is disposed between two limbs 760/1, 760/2 of the U-shaped recess 760. The fastening element 750 extends through the two limbs 760/1, 760/2. The fastening element 750 has two slide portions: on the one hand, the bearing portion 750/1 and, on the other hand, the slide portion 750/3. The bearing portion 750/1 is disposed in a bore in one limb 760/1, and the slide portion 750/3 is disposed in a bore in the other limb 760/2. For this purpose, both portions 750/1 and 750/3 are seated in a sliding manner. Seated in a sliding manner (or, also, with a slip fit) is to be understood to mean a fit between two parts that allows a slight sliding, but not an appreciable play, between the parts.

As a result, the fastening element 450 is disposed in a displaceable manner. The bearing portion 750/1 has a first, preferably round, cross-sectional face 780, and adjoining the bearing portion 750/1 is the slide portion, which has a second, preferably round, cross-sectional face 790, which is smaller than the first cross-sectional face 780. The saw blade guide 450 has a recess 800, by means of which it can be taken transversely from the fastening element 750. Disposed between the limb 760/2 and the collar 810 is a spring 830, which secures the fastening element in the locking position. Pressing on the collar 810 causes the fastening element 750 to be shifted into the unlocking position, such that the slide portion 830 comes into the region of the recess 800. The saw blade guide 450 can then be removed, and the same or a different saw blade guide can then be reinserted. It is to be noted that the length L1 of the slide portion 750/3, together with the thickness of the limb 760/2, should be at least as great, preferably somewhat greater, than the width L2 of the U-shaped recess 760.

Both exemplary embodiments render possible, in a particularly simple manner, a system consisting of at least one jigsaw 10; 100 and a plurality of saw blade guides 44; 440 for the at least one jigsaw 10; 100, wherein the saw blade guides can be designed for differing saw blades 68.

It is also conceivable or the fastening element 75 or 750 to be such that it can be locked and unlocked by means of a bayonet closure.

Instead of a roller 44, the saw blade guides 45, 450 can also have a slide bearing, along which the back of the saw blade slides.

1. A jigsaw, comprising:
at least one saw blade guide on which a back of a saw blade of the jigsaw is supported; and
a fastening element having a bearing portion on which the saw blade guide is mounted, so as to hold the saw blade guide is held on the jigsaw,
wherein the fastening element is configured to be repeatedly positioned on the jigsaw in a locking position and an unlocking position, such that the saw blade guide is configured to be exchanged.

2. The jigsaw as claimed in claim 1, wherein the fastening element has an actuating portion that is configured to be actuated to lock and unlock the fastening element.

3. The jigsaw as claimed in claim 1, wherein the fastening element has a locking portion by which the fastening element is configured to be locked and unlocked on the jigsaw.

4. The jigsaw as claimed in claim 1, wherein the saw blade guide is mounted with a pendulum motion on the bearing portion.

5. The jigsaw as claimed in claim 1, wherein the jigsaw defines a U-shaped recess for the saw blade guide, which is disposed between two limbs of the U-shaped recess, wherein the fastening element extends through the two limbs, and wherein the fastening element has at least one slide portion, which is disposed in at least one limb and is seated in a sliding manner in the limb.

6. The jigsaw as claimed in claim 1, wherein the actuating portion has defines a recess for a tool.

7. The jigsaw as claimed in claim 1, wherein the fastening element has a thread, by which the fastening element is configured to be screwed into the jigsaw.

8. The jigsaw as claimed in claim 7, wherein the thread has a coating that makes it difficult for the fastening element to be detached.

9. The jigsaw as claimed in claim 1, wherein the fastening element is disposed in a displaceable manner, wherein the bearing portion has a first cross-sectional face, wherein adjoining the bearing portion there is a slide portion having a second cross-sectional face that is smaller than the first cross-sectional face, and wherein the saw blade guide has defines a recess by which the saw blade guide is configured to be taken transversely from the fastening element.

10. A system, comprising:
at least one jigsaw, the jigsaw including:
at least one saw blade guide on which a back of a saw blade of the jigsaw is supported; and
a fastening element having a bearing portion on which the saw blade guide is mounted so as to hold the saw blade guide on the jigsaw,
wherein the fastening element is configured to be repeatedly positioned on the jigsaw in a locking position and an unlocking position such that the saw blade guide is configured to be exchanged,
wherein the at least one saw blade guide is a plurality of saw blade guides for the at least one jigsaw, the saw blade guides being designed for differing saw blades.

11. The jigsaw as claimed in claim 1, wherein the saw blade guide is mounted on the bearing portion of the fastening element with a pendulum motion.

12. The jigsaw as claimed in claim 2, wherein the actuating portion of the fastening element is configured to be actuated by a user.

13. The jigsaw as claimed in claim 6, wherein the tool is a screwdriver.
